(19) United States
(12) Patent Application Publication
(10) Pub. No.: US 2006/0208383 A1
(43) Pub. Date: Sep. 21, 2006

(54) Low cost magnets and magnetic devices manufactured from ferromagnetic conductively doped resin-based materials

(76) Inventor: Thomas Aisenbrey, Littleton, CO (US)

Correspondence Address: DOUGLAS R. SCHNABEL, 1531 WEDGEWOOD PLACE, ESSEXVILLE, MI, 48732, US

(21) Appl. No.: 11/378,068

(22) Filed: Mar. 17, 2006

Related U.S. Application Data
(60) Provisional application No. 60/662,925, filed on Mar. 17, 2005.

(51) Int. Cl. C04B 35/00

(52) U.S. Cl. 264/104

(57) ABSTRACT

Magnetic devices are formed of a ferromagnetic conductively doped resin-based material. The ferromagnetic conductively doped resin-based material comprises ferromagnetic micron conductive powder(s), ferromagnetic micron conductive fiber(s), or combinations thereof in a base resin host. The percentage by weight of the ferromagnetic micron conductive powder(s), ferromagnetic micron conductive fiber(s), or combinations is between about 20% and 50% of the weight of the ferromagnetic conductively doped resin-based material.

### RELATED PATENT APPLICATIONS

This Patent Application claims priority to the U.S. Provisional Patent Application 60/662,925 filed on Mar. 17, 2005, which is herein incorporated by reference in its entirety.

This Patent application is a Continuation-in-Part of INT01-002CIPC, filed as U.S. patent application Ser. No. 10/877,092, filed on Jun. 25, 2004, which is a Continuation of INT01-002CIP, filed as U.S. patent application Ser. No. 10/309,429, filed on Dec. 4, 2002, now issued as U.S. Pat. No. 6,870,516, also incorporated by reference in its entirety, which is a Continuation-in-Part application of docket number INT01-002, filed as U.S. patent application Ser. No. 10/075,778, filed on Feb. 14, 2002, now issued as U.S. Pat. No. 6,741,221, which claimed priority to U.S. Provisional Patent Applications Ser. No. 60/317,808, filed on Sep. 7, 2001, Ser. No. 60/269,414, filed on Feb. 16, 2001, and Ser. No. 60/268,822, filed on Feb. 15, 2001, all of which are incorporated by reference in their entirety.

### BACKGROUND OF THE INVENTION

(1) Field of the Invention

This invention relates to magnets and magnetic devices and, more particularly, to magnets and magnetic devices molded of ferromagnetic conductively doped resin-based materials comprising micron conductive powders, micron conductive fibers, or a combination thereof, substantially homogenized within a base resin when molded. This manufacturing process yields a conductive part or material usable within the EMF, thermal, acoustic, or electronic spectrum(s).

(2) Description of the Prior Art

Magnets and magnetic devices find many applications. For example, magnets are frequently used in latches, in computer memories, in motors, and in medical applications. Magnets are typically formed from metal, rare earth metals, or ceramics. The material must be able to maintain an internal magnetic polarization such that a permanent magnetic field is sustained. Metal magnets are typically dense and heavy but do not sustain a large magnetic field. Metal magnets are prone to corrosion. Ceramic magnets are light weight but are typically very brittle. Metal manufacturing processes can also be expensive and design limiting. Significant objects of the present invention are to describe a novel material that combines useful properties, typical to magnets of various types, with useful properties typical to resin-based materials to create a uniquely capable magnetic material.

Several prior art inventions relate to electromechanical devices and conductive resin-based materials. U.S. Patent Application 2003/0012948 A1 to Miura et al teaches a resin bonded rare earth magnet that is protected by an outer layer of a synthetic resin between 1 and 30 microns thick making it corrosion resistant. This invention also teaches the magnet body comprising a mixture of thermosetting resin and rare earth-transition metal alloy powder. U.S. Patent Application 2004/0094742 A1 to Kawano et al teaches a formed synthetic resin magnet and its composition comprising a resin binder, a magnetic powder, and a hindered phenol antioxidant having an improved melt flow rate. U.S. Patent Application 2004/0144960 A1 to Arai et al teaches a resin magnet composition that utilizes a deterioration inhibitor containing both a metal deactivation and a radical scavenger and a substituted urea-based lubricant to greatly contribute to the improvement of melt fluidity during processing. U.S. Pat. Nos. 5,990,218 and U.S. Pat. No. 6,359,051 B1 to Hill et al teaches a polymeric magnet compound which is a thermoplastic material rather than a thermoset, is ultraviolet light and heat resistant, and able to be injection-molded without the need for a curing step in the manufacturing process. U.S. Pat. No. 6,476,113 B1 to Hiles teaches a magnetically active flexible polymer that utilizes the process of having the magnetic filler that is packed in the elastomeric matrix aligned and energized during the molding process. U.S. Patent Application 2002/0134448 A1 to Goodman teaches a locatable magnetic polyethylene gas pipe. U.S. Patent Publication 2004/1083702 A1 to Nachtigal et al teaches a magnetizable thermoplastic elastomer.

### SUMMARY OF THE INVENTION

A principal object of the present invention is to provide an effective magnetic device.

A further object of the present invention is to provide a method to form a magnetic device.

A further object of the present invention is to provide magnetic devices molded of ferromagnetic conductively doped resin-based materials.

A yet further object of the present invention is to provide a magnetic device molded of conductively doped resin-based material where the electrical or thermal or visual characteristics can be altered by forming a metal layer over the conductively doped resin-based material.

A yet further object of the present invention is to provide methods to fabricate a magnetic device from a ferromagnetic conductively doped resin-based material incorporating various forms of the material.

In accordance with the objects of this invention, a magnetic device is achieved. The device comprises a ferromagnetic conductively doped, resin-based material comprising ferromagnetic micron conductive fiber in a base resin host. The ferromagnetic micron conductive fiber is magnetically polarized.

Also in accordance with the objects of this invention, a magnetic device is achieved. The device comprises a ferromagnetic conductively doped, resin-based material comprising ferromagnetic micron conductive fiber in a base resin host. The ferromagnetic micron conductive fiber is magnetically polarized. The ferromagnetic micron conductive fiber is between about 20% and about 50% of the total weight of the ferromagnetic conductively doped resin-based material.

Also in accordance with the objects of this invention, a method to form a magnetic device is achieved. The method comprises providing a ferromagnetic conductively doped, resin-based material comprising ferromagnetic micron conductive fiber in a resin-based host. The ferromagnetic conductively doped, resin-based material is molded and is magnetically polarized.

### BRIEF DESCRIPTION OF THE DRAWINGS

In the accompanying drawings forming a material part of this description, there is shown:

FIG. 1 illustrates an exemplary loudspeaker magnet formed of ferromagnetic conductively doped resin-based material according to the present invention.

FIG. 2 illustrates a ferromagnetic conductively doped resin-based material wherein the ferromagnetic conductive materials comprise a powder.

FIG. 3 illustrates a ferromagnetic conductively doped resin-based material wherein the ferromagnetic conductive materials comprise micron conductive fibers.

FIG. 4 illustrates a ferromagnetic conductively doped resin-based material wherein the ferromagnetic conductive materials comprise both micron powder and micron fiber.

FIGS. 5a and 5b illustrate ferromagnetic conductive fabric-like materials formed from the ferromagnetic conductively doped resin-based material.

FIGS. 6a and 6b illustrate, in simplified schematic form, an injection molding apparatus and an extrusion molding apparatus that may be used to mold articles of ferromagnetic conductively doped resin-based material.

FIG. 7 illustrates an exemplary cabinet latch formed of ferromagnetic conductively doped resin-based material according to the present invention.

FIG. 8 illustrates an exemplary magnetic electric guitar pickup formed of ferromagnetic conductively doped resin-based material according to the present invention.

FIG. 9 illustrates an exemplary cylinder magnet formed of ferromagnetic conductively doped resin-based material according to the present invention.

FIG. 10 illustrates an exemplary soft flexible wrist magnetic bracelet formed of ferromagnetic conductively doped resin-based material according to the present invention.

FIG. 11 illustrates an exemplary soft ribbon magnet formed of ferromagnetic conductively doped resin-based material according to the present invention.

FIG. 12 illustrates an exemplary magnetic film formed of ferromagnetic conductively doped resin-based material according to the present invention.

FIG. 13 illustrates an exemplary pill magnet formed of ferromagnetic conductively doped resin-based material according to the present invention.

FIG. 14 illustrates an exemplary motor magnet formed of ferromagnetic conductively doped resin-based material according to the present invention.

### DESCRIPTION OF THE PREFERRED EMBODIMENTS

This invention relates to magnets and magnetic devices molded of ferromagnetic conductively doped resin-based materials comprising micron conductive powders, micron conductive fibers, or a combination thereof, substantially homogenized within a base resin when molded.

Conductively doped resin-based materials are base resins doped with conductive materials to convert the base resin from an insulator to a conductor. The base resin provides structural integrity to the molded part. The doping material, such as micron conductive fibers, micron conductive powders, or a combination thereof, is substantially homogenized within the resin during the molding process. The resulting conductively doped resin-based material provides electrical, thermal, and acoustical continuity.

Conductively doped resin-based materials can be molded, extruded or the like to provide almost any desired shape or size. Molded conductively doped resin-based materials can also be cut, stamped, or vacuumed formed from an injection molded or extruded sheet or bar stock, over-molded, laminated, milled or the like to provide the desired shape and size. The thermal, electrical, and acoustical continuity and/or conductivity characteristics of articles or parts fabricated using conductively doped resin-based materials depend on the composition of the conductively doped resin-based materials. The type of base resin, the type of doping material, and the relative percentage of doping material incorporated into the base resin can be adjusted to achieve the desired structural, electrical, or other physical characteristics of the molded material. The selected materials used to fabricate the articles or devices are substantially homogenized together using molding techniques and or methods such as injection molding, over-molding, insert molding, compression molding, thermo-set, protrusion, extrusion, calendaring, or the like. Characteristics related to 2D, 3D, 4D, and 5D designs, molding and electrical characteristics, include the physical and electrical advantages that can be achieved during the molding process of the actual parts and the molecular polymer physics associated within the conductive networks within the molded part(s) or formed material(s).

In conductively doped resin-based material, electrons travel from point to point, following the path of least resistance. Most resin-based materials are insulators and represent a high resistance to electron passage. The doping of the conductive loading into the resin-based material alters the inherent resistance of the polymers. At a threshold concentration of conductive loading, the resistance through the combined mass is lowered enough to allow electron movement. Speed of electron movement depends on conductive doping concentration and material makeup, that is, the separation between the conductive doping particles. Increasing conductive loading content reduces interparticle separation distance, and, at a critical distance known as the percolation point, resistance decreases dramatically and electrons move rapidly.

Resistivity is a material property that depends on the atomic bonding and on the microstructure of the material. The atomic microstructure material properties within the conductively doped resin-based material are altered when molded into a structure. A substantially homogenized conductive microstructure of delocalized valance electrons is created within the valance and conduction bands of the molecules. This microstructure provides sufficient charge carriers within the molded matrix structure. As a result, a low density, low resistivity, lightweight, durable, resin based polymer microstructure material is achieved. This material exhibits conductivity comparable to that of highly conductive metals such as silver, copper or aluminum, while maintaining the superior structural characteristics found in many plastics and rubbers or other structural resin based materials.

Conductively doped resin-based materials lower the cost of materials and of the design and manufacturing processes needed for fabrication of molded articles while maintaining close manufacturing tolerances. The molded articles can be manufactured into infinite shapes and sizes using conventional forming methods such as injection molding, over-molding, compression molding, thermoset molding, or extrusion, calendaring, or the like. The conductively doped resin-based materials, when molded, typically but not exclusively produce a desirable usable range of resistivity of less than about 5 to more than about 25 ohms per square, but other resistivities can be achieved by varying the dopant(s), the doping parameters and/or the base resin selection(s).

Conductively doped resin-based materials comprise micron conductive powders, micron conductive fibers, or any combination thereof, which are substantially homogenized together within the base resin, during the molding process, yielding an easy to produce low cost, electrical, thermal, and acoustical performing, close tolerance manufactured part or circuit. The resulting molded article comprises a three dimensional, continuous capillary network of conductive doping particles contained and or bonding within the polymer matrix. Exemplary micron conductive powders include carbons, graphites, amines, eeonomers, or the like, and/or of metal powders such as nickel, copper, silver, aluminum, nichrome, or plated or the like. The use of carbons or other forms of powders such as graphite(s) etc. can create additional low level electron exchange and, when used in combination with micron conductive fibers, creates a micron filler element within the micron conductive network of fiber(s) producing further electrical conductivity as well as acting as a lubricant for the molding equipment. Carbon nano-tubes may be added to the conductively doped resin-based material. The addition of conductive powder to the micron conductive fiber doping may improve the electrical continuity on the surface of the molded part to offset any skinning effect that occurs during molding.

The micron conductive fibers may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, melamine, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

Where micron fiber is combined with base resin, the micron fiber may be pretreated to improve performance. According to one embodiment of the present invention, conductive or non-conductive powders are leached into the fibers prior to extrusion. In other embodiments, the fibers are subjected to any or several chemical modifications in order to improve the fibers interfacial properties. Fiber modification processes include, but are not limited to: chemically inert coupling agents; gas plasma treatment; anodizing; mercerization; peroxide treatment; benzoylation; or other chemical or polymer treatments.

Chemically inert coupling agents are materials that are molecularly bonded onto the surface of metal and or other fibers to provide surface coupling, mechanical interlocking, inter-difussion and adsorption and surface reaction for later bonding and wetting within the resin-based material. This chemically inert coupling agent does not react with the resin-based material. An exemplary chemically inert coupling agent is silane. In a silane treatment, silicon-based molecules from the silane bond to the surface of metal fibers to form a silicon layer. The silicon layer bonds well with the subsequently extruded resin-based material yet does not react with the resin-based material. As an additional feature during a silane treatment, oxane bonds with any water molecules on the fiber surface to thereby eliminate water from the fiber strands. Silane, amino, and silane-amino are three exemplary pre-extrusion treatments for forming chemically inert coupling agents on the fiber.

In a gas plasma treatment, the surfaces of the metal fibers are etched at atomic depths to re-engineer the surface. Cold temperature gas plasma sources, such as oxygen and ammonia, are useful for performing a surface etch prior to extrusion. In one embodiment of the present invention, gas plasma treatment is first performed to etch the surfaces of the fiber strands. A silane bath coating is then performed to form a chemically inert silicon-based film onto the fiber strands. In another embodiment, metal fiber is anodized to form a metal oxide over the fiber. The fiber modification processes described herein are useful for improving interfacial adhesion, improving wetting during homogenization, and/or reducing oxide growth (when compared to non-treated fiber). Pretreatment fiber modification also reduces levels of particle dust, fines, and fiber release during subsequent capsule sectioning, cutting or vacuum line feeding.

The resin-based structural material may be any polymer resin or combination of compatible polymer resins. Non-conductive resins or inherently conductive resins may be used as the structural material. Conjugated polymer resins, one example being polythiophene, may be used as the structural material. Complex polymer resins, examples being polyimide and polyamide, may be used as the structural material. Inherently conductive resins may be used as the structural material. The dielectric properties of the resin-based material will have a direct effect upon the final electrical performance of the conductively doped resin-based material. Many different dielectric properties are possible depending on the chemical makeup and/or arrangement, such as linking, cross-linking or the like, of the polymer, co-polymer, monomer, ter-polymer, or homo-polymer material. Structural material can be, here given as examples and not as an exhaustive list, polymer resins produced by GE PLASTICS, Pittsfield, Mass., a range of other plastics produced by GE PLASTICS, Pittsfield, Mass., a range of other plastics produced by other manufacturers, silicones produced by GE SILICONES, Waterford, N.Y., or other flexible resin-based rubber compounds produced by other manufacturers.

The resin-based structural material doped with micron conductive powders, micron conductive fibers, or in combination thereof can be molded, using conventional molding methods such as injection molding or over-molding, or extrusion to create desired shapes and sizes. The molded conductively doped resin-based materials can also be stamped, cut or milled as desired to form create the desired shapes and form factor(s). The doping composition and directionality associated with the micron conductors within the doped base resins can affect the electrical and structural characteristics of the articles and can be precisely controlled by mold designs, gating and or protrusion design(s) and or during the molding process itself. In addition, the resin base can be selected to obtain the desired thermal characteristics such as very high melting point or specific thermal conductivity.

A resin-based sandwich laminate could also be fabricated with random or continuous webbed micron stainless steel fibers or other conductive fibers, forming a cloth like material. The webbed conductive fiber can be laminated or the like to materials such as Teflon, Polyesters, or any resin-based flexible or solid material(s), which when discretely designed in fiber content(s), orientation(s) and shape(s), will produce a very highly conductive flexible cloth-like material. Such a cloth-like material could also be used in forming articles that could be embedded in a person's clothing as well as other resin materials such as rubber(s) or plastic(s). When using conductive fibers as a webbed conductor as part of a laminate or cloth-like material, the fibers may have diameters of between about 3 and 12 microns, typically between about 8 and 12 microns or in the range of about 10 microns, with length(s) that can be seamless or overlapping.

The conductively doped resin-based material may also be formed into a prepreg laminate, cloth, or webbing. A laminate, cloth, or webbing of the conductively doped resin-based material is first homogenized with a resin-based material. In various embodiments, the conductively doped resin-based material is dipped, coated, sprayed, and/or extruded with resin-based material to cause the laminate, cloth, or webbing to adhere together in a prepreg grouping that is easy to handle. This prepreg is placed, or laid up, onto a form and is then heated to form a permanent bond. In another embodiment, the prepreg is laid up onto the impregnating resin while the resin is still wet and is then cured by heating or other means. In another embodiment, the wet lay-up is performed by laminating the conductively doped resin-based prepreg over a honeycomb structure. In another embodiment, the honeycomb structure is made from conductively doped, resin-based material. In yet another embodiment, a wet prepreg is formed by spraying, dipping, or coating the conductively doped resin-based material laminate, cloth, or webbing in high temperature capable paint.

Prior art carbon fiber and resin-based composites are found to display unpredictable points of failure. In carbon fiber systems there is little if any elongation of the structure. By comparison, in the present invention, the conductively doped resin-based material, even if formed with carbon fiber or metal plated carbon fiber, displays greater strength of the mechanical structure due to the substantial homogenization of the fiber created by the moldable capsules. As a result a structure formed of the conductively doped resin-based material of the present invention will maintain structurally even if crushed while a comparable carbon fiber composite will break into pieces.

The conductively doped resin-based material of the present invention can be made resistant to corrosion and/or metal electrolysis by selecting micron conductive fiber and/or micron conductive powder dopants and base resins that are resistant to corrosion and/or metal electrolysis. For example, if a corrosion/electrolysis resistant base resin is combined with fibers/powders or in combination of such as stainless steel fiber, inert chemical treated coupling agent warding against corrosive fibers such as copper, silver and gold and or carbon fibers/powders, then corrosion and/or metal electrolysis resistant conductively doped resin-based material is achieved. Another additional and important feature of the present invention is that the conductively doped resin-based material of the present invention may be made flame retardant. Selection of a flame-retardant (FR) base resin material allows the resulting product to exhibit flame retardant capability. This is especially important in applications as described herein.

The substantially homogeneous mixing of micron conductive fiber and/or micron conductive powder and base resin described in the present invention may also be described as doping. That is, the substantially homogeneous mixing transforms a typically non-conductive base resin material into a conductive material. This process is analogous to the doping process whereby a semiconductor material, such as silicon, can be converted into a conductive material through the introduction of donor/acceptor ions as is well known in the art of semiconductor devices. Therefore, the present invention uses the term doping to mean converting a typically non-conductive base resin material into a conductive material through the substantially homogeneous mixing of micron conductive fiber and/or micron conductive powder within a base resin.

As an additional and important feature of the present invention, the molded conductor doped resin-based material exhibits excellent thermal dissipation characteristics. Therefore, articles manufactured from the molded conductor doped resin-based material can provide added thermal dissipation capabilities to the application. For example, heat can be dissipated from electrical devices physically and/or electrically connected to an article of the present invention.

As a significant advantage of the present invention, articles constructed of the conductively doped resin-based material can be easily interfaced to an electrical circuit or grounded. In one embodiment, a wire can be attached to conductively doped resin-based articles via a screw that is fastened to the article. For example, a simple sheet-metal type, self tapping screw can, when fastened to the material, can achieve excellent electrical connectivity via the conductive matrix of the conductively doped resin-based material. To facilitate this approach a boss may be molded as part of the conductively doped resin-based material to accommodate such a screw. Alternatively, if a solderable screw material, such as copper, is used, then a wire can be soldered to the screw is embedded into the conductively doped resin-based material. In another embodiment, the conductively doped resin-based material is partly or completely plated with a metal layer. The metal layer forms excellent electrical conductivity with the conductive matrix. A connection of this metal layer to another circuit or to ground is then made. For example, if the metal layer is solderable, then a soldered connection may be made between the article and a grounding wire.

Where a metal layer is formed over the surface of the conductively doped resin-based material, any of several techniques may be used to form this metal layer. This metal layer may be used for visual enhancement of the molded conductively doped resin-based material article or to otherwise alter performance properties. Well-known techniques, such as electroless metal plating, electro plating, electrolytic metal plating, sputtering, metal vapor deposition, metallic painting, or the like, may be applied to the formation of this metal layer. If metal plating is used, then the resin-based structural material of the conductively doped, resin-based material is one that can be metal plated. There are many of the polymer resins that can be plated with metal layers. For example, GE Plastics, SUPEC, VALOX, ULTEM, CYCOLAC, UGIKRAL, STYRON, CYCOLOY are a few resin-based materials that can be metal plated. Electroless plating is typically a multiple-stage chemical process where, for example, a thin copper layer is first deposited to form a conductive layer. This conductive layer is then used as an electrode for the subsequent plating of a thicker metal layer.

A typical metal deposition process for forming a metal layer onto the conductively doped resin-based material is vacuum metallization. Vacuum metallization is the process where a metal layer, such as aluminum, is deposited on the conductively doped resin-based material inside a vacuum chamber. In a metallic painting process, metal particles, such as silver, copper, or nickel, or the like, are dispersed in an acrylic, vinyl, epoxy, or urethane binder. Most resin-based materials accept and hold paint well, and automatic spraying systems apply coating with consistency. In addition, the excellent conductivity of the conductively doped resin-based material of the present invention facilitates the use of extremely efficient, electrostatic painting techniques.

The conductively doped resin-based materials can be contacted in any of several ways. In one embodiment, a pin is embedded into the conductively doped resin-based material by insert molding, ultrasonic welding, pressing, or other means. A connection with a metal wire can easily be made to this pin and results in excellent contact to the conductively doped resin-based material conductive matrix. In another embodiment, a hole is formed in to the conductively doped resin-based material either during the molding process or by a subsequent process step such as drilling, punching, or the like. A pin is then placed into the hole and is then ultrasonically welded to form a permanent mechanical and electrical contact. In yet another embodiment, a pin or a wire is soldered to the conductively doped resin-based material. In this case, a hole is formed in the conductively doped resin-based material either during the molding operation or by drilling, stamping, punching, or the like. A solderable layer is then formed in the hole. The solderable layer is preferably formed by metal plating. A conductor is placed into the hole and then mechanically and electrically bonded by point, wave, or reflow soldered.

Another method to provide connectivity to the conductively doped resin-based material is through the application of a solderable ink film to the surface. One exemplary solderable ink is a combination of copper and solder particles in an epoxy resin binder. The resulting mixture is an active, screen-printable and dispensable material. During curing, the solder reflows to coat and to connect the copper particles and to thereby form a cured surface that is directly solderable without the need for additional plating or other processing steps. Any solderable material may then be mechanically and/or electrically attached, via soldering, to the conductively doped resin-based material at the location of the applied solderable ink. Many other types of solderable inks can be used to provide this solderable surface onto the conductively doped resin-based material of the present invention. Another exemplary embodiment of a solderable ink is a mixture of one or more metal powder systems with a reactive organic medium. This type of ink material is converted to solderable pure metal during a low temperature cure without any organic binders or alloying elements.

As an important feature of the present invention, a ferromagnetic conductively doped resin-based material may be formed of the present invention to create a magnetic or magnetizable form of the material. Ferromagnetic micron conductive fibers and/or ferromagnetic conductive powders are substantially homogenized with the base resin. Ferrite materials and/or rare earth magnetic materials are added as a conductive doping to the base resin. With the substantially homogeneous mixing of the ferromagnetic micron conductive fibers and/or micron conductive powders, the ferromagnetic conductively doped resin-based material is able to produce an excellent low cost, low weight, high aspect ratio magnetize-able item. The magnets and magnetic devices of the present invention can be magnetized during or after the molding process. Adjusting the doping levels and or dopants of ferromagnetic micron conductive fibers and/or ferromagnetic micron conductive powders that are homogenized within the base resin can control the magnetic strength of the magnets and magnetic devices. By increasing the aspect ratio of the ferromagnetic doping, the strength of the magnet or magnetic devices can be substantially increased. The substantially homogenous mixing of the conductive fibers/powders or in combinations there of allows for a substantial amount of dopants to be added to the base resin without causing the structural integrity of the item to decline mechanically. The ferromagnetic conductively doped resin-based magnets display outstanding physical properties of the base resin, including flexibility, moldability, strength, and resistance to environmental corrosion, along with superior magnetic ability. In addition, the unique ferromagnetic conductively doped resin-based material facilitates formation of items that exhibit superior thermal and electrical conductivity as well as magnetism.

A high aspect ratio magnet is easily achieved through the use of ferromagnetic conductive micron fiber or through the combination of ferromagnetic micron powder with conductive micron fiber. The use of micron conductive fiber allows for molding articles with a high aspect ratio of conductive fibers/powders or combinations there of in a cross sectional area. If a ferromagnetic micron fiber is used, then this high aspect ratio translates into a high quality magnetic article. Alternatively, if a ferromagnetic micron powder is combined with micron conductive fiber, then the magnetic effect of the powder is effectively spread throughout the molded article via the network of conductive fiber such that an effective high aspect ratio molded magnetic article is achieved. The ferromagnetic conductively doped resin-based material may be magnetized, after molding, by exposing the molded article to a strong magnetic field. Alternatively, a strong magnetic field may be used to magnetize the ferromagnetic conductively doped resin-based material during the molding process.

The ferromagnetic conductively doped is in the form of fiber, powder, or a combination of fiber and powder. The micron conductive powder may be metal fiber or metal plated fiber or powders. If metal plated fiber is used, then the core fiber is a platable material and may be metal or non-metal. Exemplary ferromagnetic conductive fiber materials include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive fiber materials. Exemplary ferromagnetic micron powder leached onto the conductive fibers include ferrite, or ceramic, materials as nickel zinc, manganese zinc, and combinations of iron, boron, and strontium, and the like. In addition, rare earth elements, such as neodymium and samarium, typified by neodymium-iron-boron, samarium-cobalt, and the like, are useful ferromagnetic conductive powder materials. A ferromagnetic conductive doping may be combined with a non-ferromagnetic conductive doping to form a conductively doped resin-based material that combines excellent conductive qualities with magnetic capabilities.

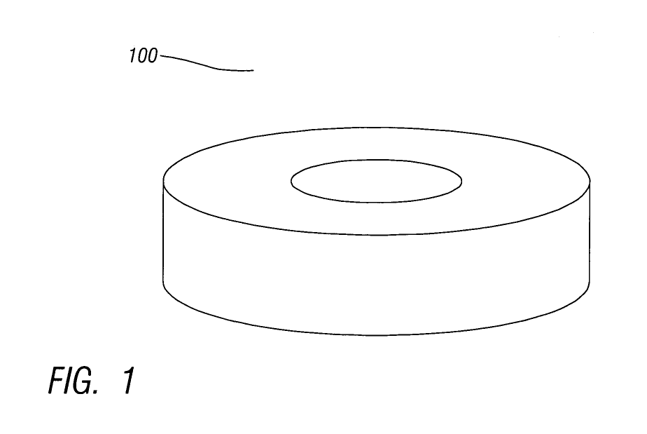

Referring now to FIG. 1, a first preferred embodiment of the present invention is illustrated. A pair of loudspeaker magnets 100 is shown. The loudspeaker magnets 100 comprise the ferromagnetic conductively doped resin-based material of the present invention. The loudspeaker magnets 100 are formed by for example, extrusion.

The loudspeaker magnet 100 formed of the ferromagnetic conductively doped resin-based material allows for a much lighter weight speaker frame to be used due to the reduced weight of the magnet. Another advantage that is realized by forming magnets and magnetic devices from ferromagnetic conductively doped resin-based materials is the durability of the items that are formed. A magnet or magnetic device formed of the conductively doped resin-based material, with proper base resin selection, can be manufactured to withstand extreme impacts without breaking. By comparison, typical magnets formed by sintering ferrite powdered metal are quite brittle.

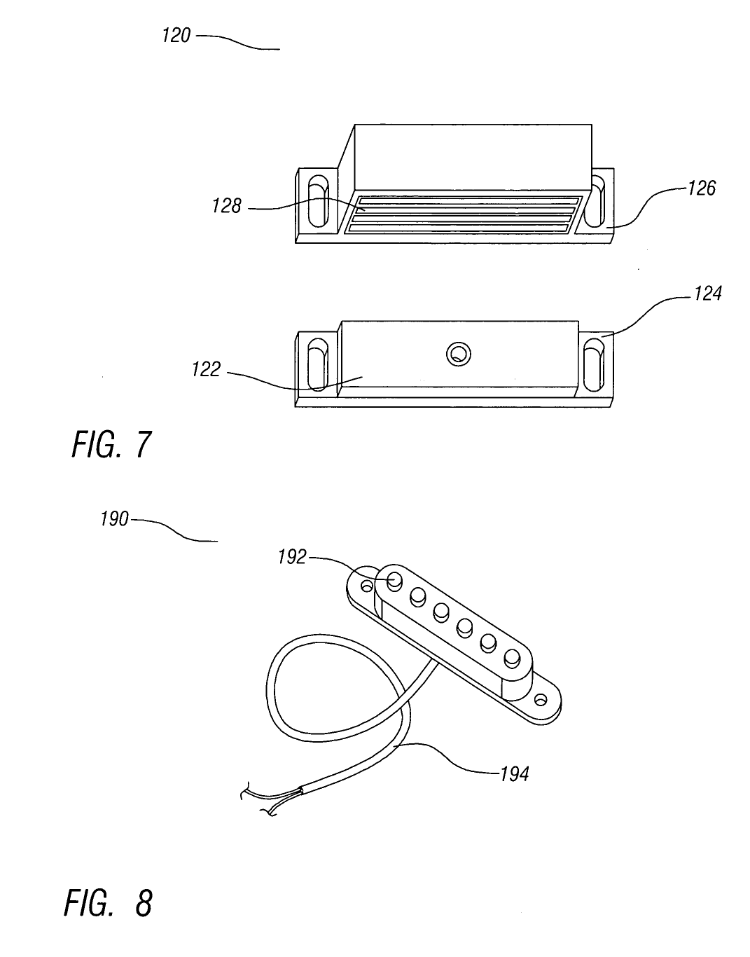

Referring now to FIG. 7, a second preferred embodiment of the present invention is illustrated. A cabinet latch 120 is shown. The cabinet latch 120 comprises the ferromagnetic ferromagnetic conductively doped resin-based material of the present invention. In the embodiment any component or several components of the cabinet latch 120 comprise the ferromagnetic conductively doped resin-based material. In various embodiments, the catch plate 122, door plate 124, magnet 128, and the magnet housing 126 comprise the ferromagnetic conductively doped resin-based material.

In this preferred embodiment the catch plate 122 is molded of the ferromagnetic conductively doped resin-based material of the present invention. The catch plate 122 is then subjected to a strong magnetic field in order to magnetize the plate 122. In another embodiment the catch plate 122 is subjected to a strong magnetic field during the molding process. In yet another embodiment the catch plate 122 is formed of metal. The door plate 24 and the magnet housing 126 serve to hold the catch plate 122 and the magnet 128 into proper alignment and are typically formed of a non-conductive resin-based material.

The cabinet latch 120 secures a cabinet door in the closed position by magnet force. The door plate 124 is secured to the cabinet door (not shown) and aligns the magnetic plate 122 with the magnet 128 inside the magnet housing 126 that is attached to the inside wall of the cabinet (not shown).

Referring no to FIG. 8, a third preferred embodiment of the present invention is illustrated. A magnetic electric guitar pickup 190 is shown. The electric guitar pickup 190 comprises the ferromagnetic conductively doped resin-based material of the present invention. In the embodiment any component or several components comprise the ferromagnetic conductively doped resin-based material. In various embodiments, the magnet (not shown), pole pieces 192, coil (not shown), and the conductor 194 comprises the ferromagnetic conductively doped resin-based material of the present invention.

Typical magnetic guitar pickup construction utilizes a copper wire wrapped around a core that is placed on a magnet. The pole pieces 92, which may or may not be magnetic, are placed inside the coil connecting to the magnet and positioned under each individual string. When a string is vibrated, it warps the magnetic flux lines in the magnetic field and causes them to vibrate. The vibration causes motion of the flux lines relative to the coil of copper wire and generates an electric signal. The signal is then sent through the conductor 94 to eventually be processed and amplified by a guitar amplifier. The output or signal strength of the pickup can be made stronger by increasing the number of turns of the copper wire on the core or by increasing the strength of the magnet.

In the embodiment the magnet is on the underside of the magnetic electric guitar pickup 190. The magnet is molded of the ferromagnetic conductively doped resin-based material of the present invention. After the magnet is molded it is subjected to a strong magnetic field in order to render it magnetic. In another embodiment the magnet is subjected to a strong magnetic field during the molding process in order to render it magnetic.

In this preferred embodiment the pole pieces 192 are formed of the ferromagnetic conductively doped resin-based material of the present invention. After the pole pieces 192 are molded they are subjected to a strong magnetic field in order to render them magnetic. In another embodiment the pole pieces are subjected to a strong magnetic field during the molding process in order to render them magnetic. In yet another embodiment the pole pieces 192 are molded of the non-ferromagnetic conductively doped resin-based material and not magnetized. In yet another embodiment the pole pieces 92 are formed of metal.

In the preferred embodiment the conductor 94 that caries the electrically generated signal to be processed is formed of the non-ferromagnetic conductively doped resin-based material. In another embodiment the conductor 94 is formed of metal wire.

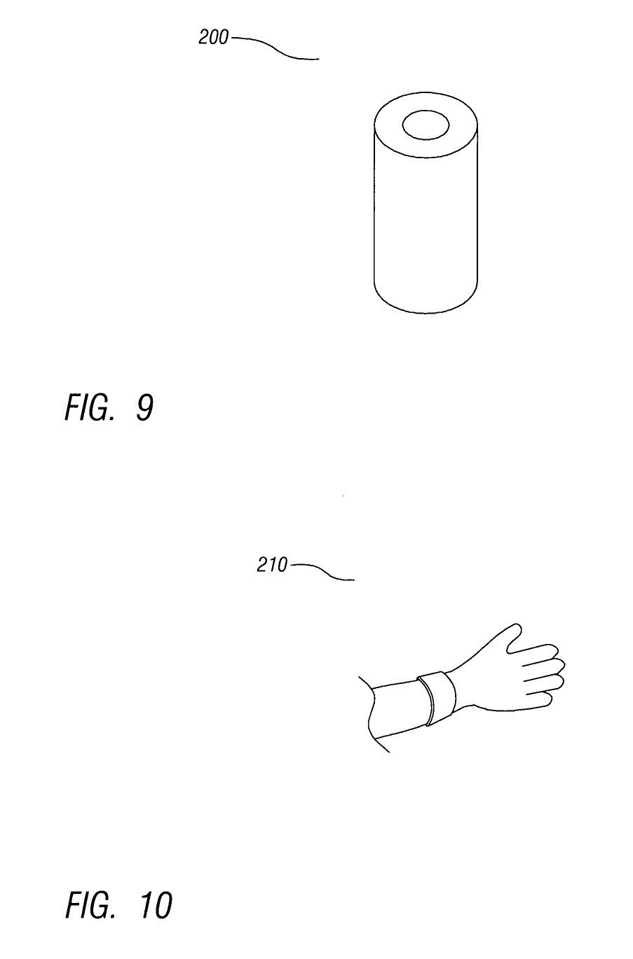

Referring now to FIG. 9, a fourth preferred embodiment of the present invention is illustrated. A cylinder magnet 200 is shown. The cylinder magnet 200 comprises the ferromagnetic conductively doped resin-based material of the present invention. The cylinder magnet 200 shown is representative of the type that is typically used in smaller electromechanical devices such as a solenoid or a relay. In this particular embodiment the cylinder magnet 200 is extruded into long sections. The long sections are then subjected to a strong magnetic field in order to render them magnetic. After the sections are magnetized they are cut to the desired length. In another embodiment the cylinder magnet 200 is extruded into long sections, cut to size, and then subjected to a strong magnetic field in order to render them magnetic. In yet another embodiment the cylinder magnet 200 subjected to a strong magnetic field during the extrusion process, in order to render them magnetic, and then cut to size.

Many people claim that physical pain is lessened by magnetic therapy. This therapy typically involves placing a permanent magnet or several permanent magnets at close proximity to the pain site. Due to the lower magnetic field that is associated with flexible magnets, the therapy usually involves placing many smaller, stronger magnets in a flexible clothing item. The small, non-flexible magnets provide a greater magnetic field but tend to be uncomfortable and non-conforming to the body.

Referring now to FIG. 10, a fifth preferred embodiment of the present invention is illustrated. A soft flexible wrist magnet 210 is shown. The soft flexible wrist magnet 210 comprises the ferromagnetic conductively doped resin-based material of the present invention. In this preferred embodiment the wrist magnet 210 comprises an inner flexible core of the ferromagnetic conductively doped resin-based material and is covered by a cloth-like covering. In the embodiment the wrist magnet 210 is molded with a flexible base resin. The flexible base resin is selected from any number of resins that will yield a stretchable item.

In the embodiment the wrist magnet 210 is molded and then subjected to a strong magnetic field in order to render it magnetic. In another embodiment the wrist magnet 210 is subjected to a strong magnetic field during the molding process in order to magnetize it. In this embodiment the wrist magnet 110 has a cloth-like flexible covering. In another embodiment the wrist magnet 210 is not covered with the cloth-like flexible covering. The soft flexible wrist magnet 210 is representative of any number of flexible magnets that can be molded from the ferromagnetic conductively doped resin-based material of the present invention. Other examples would include items such as gloves, rings, slacks, shirts, headbands, ankle wraps, shoes, and the like.

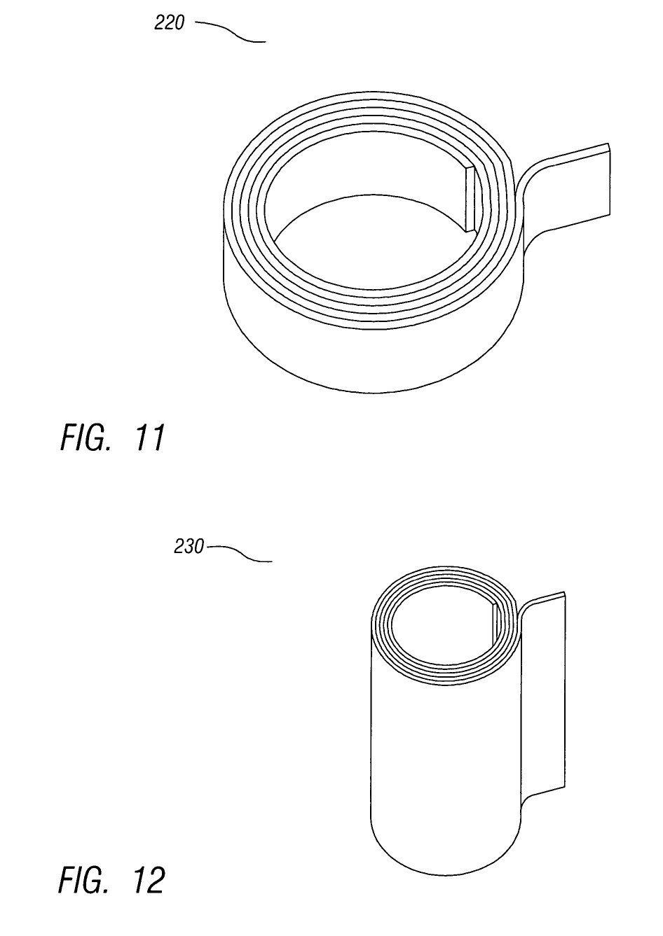

Referring now to FIG. 11, a sixth preferred embodiment of the present invention is illustrated. A soft ribbon magnet 220 is shown. The soft ribbon magnet 220 comprises the ferromagnetic conductively doped resin-based material of the present invention.

Typical soft ribbon magnets 220 are used, for example, as gaskets on refrigeration doors. The refrigeration door gaskets often utilize a resistive heat element inside them when they are used on a freezer door application. The resistive heat element helps to keep the door from freezing shut due to the condensation that forms during opening and closing the door. With ribbon magnets 120 formed of ferromagnetic conductively doped resin-based materials, a separate resistive heat element not necessary. The ferromagnetic conductively doped resin-based material of the present invention has been proven to be an excellent resistive heat element due to the conductive matrix of the fiber network.

In this preferred embodiment the soft ribbon magnet 220 is extruded and then subjected to a strong magnetic field to render it magnetic. In another embodiment the soft ribbon magnet is subjected to a strong magnetic field during the extrusion process in order to magnetize it. In one embodiment the soft ribbon magnet 220 is used as the resistive heat element in a door gasket. In another embodiment the soft ribbon magnet 220 is extruded with a channel to allow for a separate resistive heat element such as a Ni-Chrome wire. The soft ribbon magnet 120 is representative of any number of shapes and sizes of soft ribbon magnets that can be formed of the ferromagnetic conductively doped resin-based material of the present invention.

Referring now to FIG. 12, a seventh preferred embodiment of the present invention is illustrated. A roll of magnetic film 130 is shown. The magnetic film 230 comprises the ferromagnetic conductively doped resin-based material of the present invention. In the embodiment the magnetic film 230 is molded and then subjected to a strong magnetic field in order to render it magnetic. In another embodiment the magnetic film 230 is subjected to a strong magnetic field during the molding process in order to magnetize it. The magnetic film 230 is representative of any number of shapes and sizes of magnetic films that can be formed of the ferromagnetic conductively doped resin-based material of the present invention.

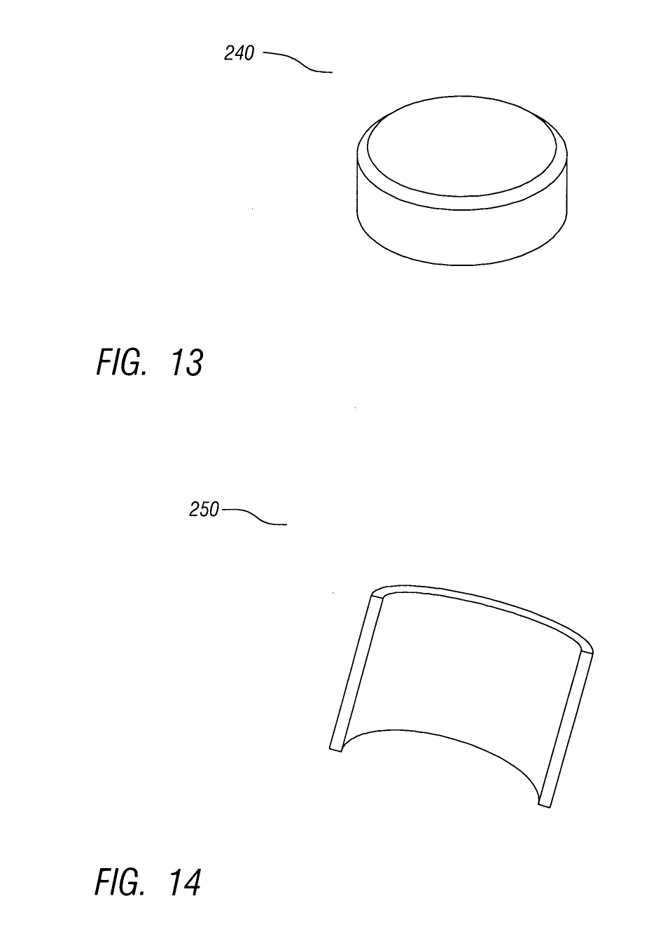

Referring now to FIG. 13, an eighth preferred embodiment of the present invention is illustrated. A pill magnet 240 is shown. The pill magnet comprises the ferromagnetic conductively doped resin-based material of the present invention. In the embodiment the pill magnet 240 is molded and then subjected to a strong magnetic field in order to render it magnetic. In another embodiment the pill magnet 240 is subjected to a strong magnetic field during the molding process in order to magnetize it. The pill magnet 240 is representative of any number of shapes and sizes of pill magnets that can be formed of the conductively doped resin-based material of the present invention.

Referring now to FIG. 14, a ninth preferred embodiment of the present invention is illustrated. A motor magnet 250 for a small motor is shown. The motor magnet 250 comprises the ferromagnetic conductively doped resin-based material of the present invention. In the embodiment the motor magnet 250 is molded and then subjected to a strong magnetic field in order to render it magnetic. In another embodiment the motor magnet 250 is subjected to a strong magnetic field during the molding process in order to magnetize it. The motor magnet 250 is representative of any number of shapes and sizes of motor magnets that can be formed of the ferromagnetic conductively doped resin-based material of the present invention.

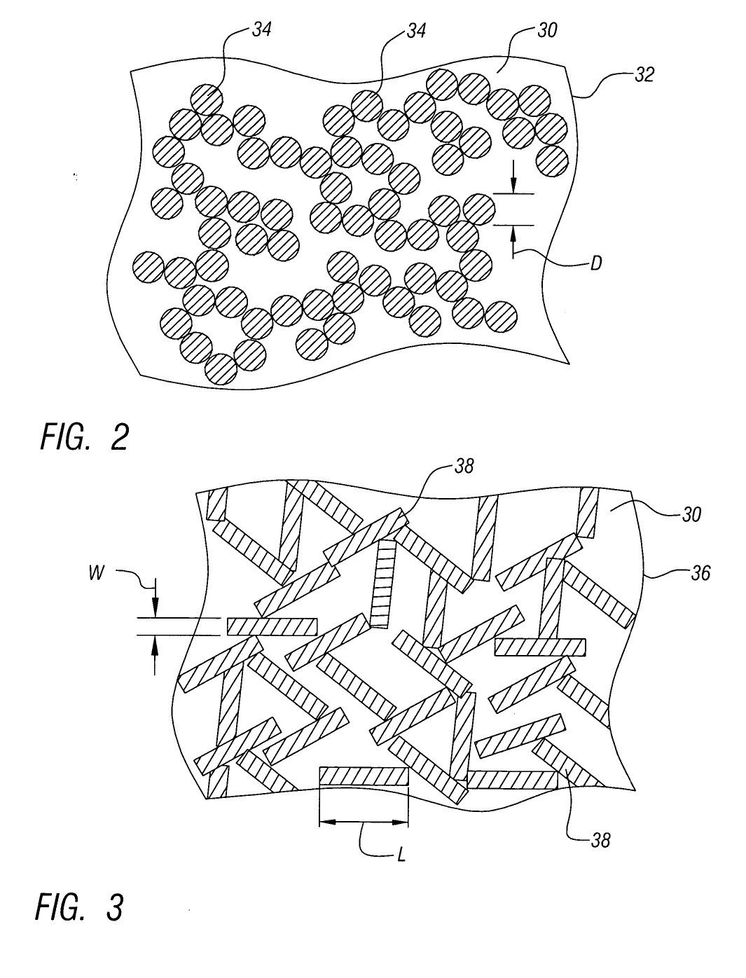

The conductively doped resin-based material typically comprises a micron powder(s) of conductor particles and/or in combination of micron fiber(s) substantially homogenized within a base resin host. FIG. 2 shows a cross section view of an example of conductively doped resin-based material 32 having powder of conductor particles 34 in a base resin host 30. In this example the diameter D of the conductor particles 34 in the powder is between about 3 and 12 microns.

FIG. 3 shows a cross section view of an example of conductively doped resin-based material 36 having conductor fibers 38 in a base resin host 30. The conductor fibers 38 have a diameter of between about 3 and 12 microns, typically in the range of 10 microns or between about 8 and 12 microns, and a length of between about 2 and 14 millimeters. The micron conductive fibers 38 may be metal fiber or metal plated fiber. Further, the metal plated fiber may be formed by plating metal onto a metal fiber or by plating metal onto a non-metal fiber. Exemplary metal fibers include, but are not limited to, stainless steel fiber, copper fiber, nickel fiber, silver fiber, aluminum fiber, nichrome fiber, or the like, or combinations thereof. Exemplary metal plating materials include, but are not limited to, copper, nickel, cobalt, silver, gold, palladium, platinum, ruthenium, rhodium, and nichrome, and alloys of thereof. Any platable fiber may be used as the core for a non-metal fiber. Exemplary non-metal fibers include, but are not limited to, carbon, graphite, polyester, basalt, man-made and naturally-occurring materials, and the like. In addition, superconductor metals, such as titanium, nickel, niobium, and zirconium, and alloys of titanium, nickel, niobium, and zirconium may also be used as micron conductive fibers and/or as metal plating onto fibers in the present invention.

These conductor particles and/or fibers are substantially homogenized within a base resin. As previously mentioned, the conductively doped resin-based materials have a sheet resistance of less than about 5 to more than about 25 ohms per square, though other values can be achieved by varying the doping parameters and/or resin selection. To realize this sheet resistance the weight of the conductor material comprises between about 20% and about 50% of the total weight of the conductively doped resin-based material. More preferably, the weight of the conductive material comprises between about 20% and about 40% of the total weight of the conductively doped resin-based material. More preferably yet, the weight of the conductive material comprises between about 25% and about 35% of the total weight of the conductively doped resin-based material. Still more preferably yet, the weight of the conductive material comprises about 30% of the total weight of the conductively doped resin-based material. Stainless Steel Fiber of 6-12 micron in diameter and lengths of 4-6 mm and comprising, by weight, about 30% of the total weight of the conductively doped resin-based material will produce a very highly conductive parameter, efficient within any EMF, thermal, acoustic, or electronic spectrum.

In yet another preferred embodiment of the present invention, the conductive doping is determined using a volume percentage. In a most preferred embodiment, the conductive doping comprises a volume of between about 4% and about 10% of the total volume of the conductively doped resin-based material. In a less preferred embodiment, the conductive doping comprises a volume of between about 1% and about 50% of the total volume of the conductively doped resin-based material though the properties of the base resin may be impacted by high percent volume doping.

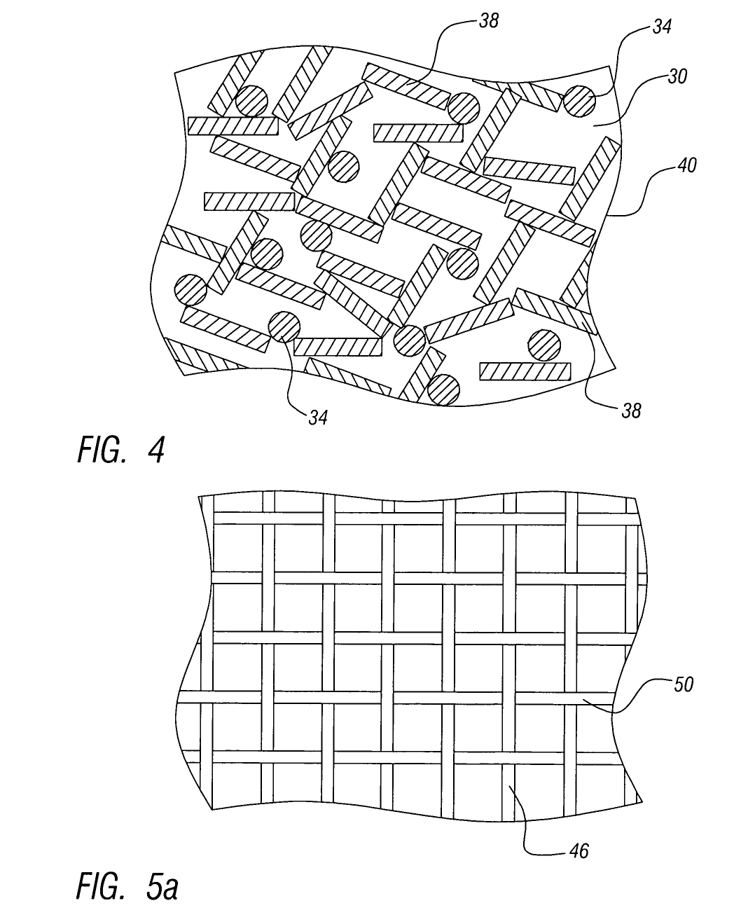

Referring now to FIG. 4, another preferred embodiment of the present invention is illustrated where the conductive materials comprise a combination of both conductive powders 34 and micron conductive fibers 38 substantially homogenized together within the resin base 30 during a molding process.

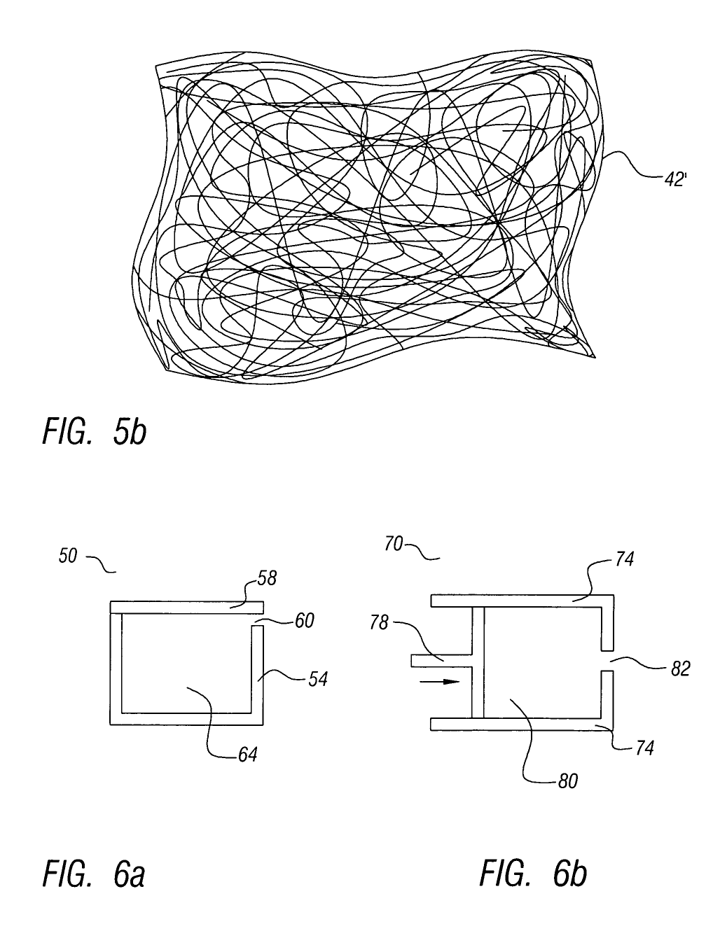

Referring now to FIGS. 5a and 5b, a preferred composition of the conductively doped, resin-based material is illustrated. The conductively doped resin-based material can be formed into fibers or textiles that are then woven or webbed into a conductive fabric. The conductively doped resin-based material is formed in strands that can be woven as shown. FIG. 5a shows a conductive fabric 42 where the fibers are woven together in a two-dimensional weave 46 and 50 of fibers or textiles. FIG. 5b shows a conductive fabric 42′ where the fibers are formed in a webbed arrangement. In the webbed arrangement, one or more continuous strands of the conductive fiber are nested in a random fashion. The resulting conductive fabrics or textiles 42, see FIG. 5a, and 42′, see FIG. 5b, can be made very thin, thick, rigid, flexible or in solid form(s).

Similarly, a conductive, but cloth-like, material can be formed using woven or webbed micron stainless steel fibers, or other micron conductive fibers. These woven or webbed conductive cloths could also be sandwich laminated to one or more layers of materials such as Polyester(s), Teflon(s), Kevlar(s) or any other desired resin-based material(s). This conductive fabric may then be cut into desired shapes and sizes.

Articles formed from conductively doped resin-based materials can be formed or molded in a number of different ways including injection molding, extrusion, calendaring, compression molding, thermoset molding, or chemically induced molding or forming. FIG. 6a shows a simplified schematic diagram of an injection mold showing a lower portion 54 and upper portion 58 of the mold 50. Conductively doped resin-based material is injected into the mold cavity 64 through an injection opening 60 and then the substantially homogenized conductive material cures by thermal reaction. The upper portion 58 and lower portion 54 of the mold are then separated or parted and the articles are removed.

FIG. 6b shows a simplified schematic diagram of an extruder 70 for forming articles using extrusion. Conductively doped resin-based material(s) is placed in the hopper 80 of the extrusion unit 74. A piston, screw, press or other means 78 is then used to force thermally molten, chemically-induced compression, or thermoset curing conductively doped resin-based material through an extrusion opening 82 which shapes the thermally molten curing or chemically induced cured conductively doped resin-based material to the desired shape. The conductively doped resin-based material is then fully cured by chemical reaction or thermal reaction to a hardened or pliable state and is ready for use. Thermoplastic or thermosetting resin-based materials and associated processes may be used in molding the conductively doped resin-based articles of the present invention.

The advantages of the present invention may now be summarized. An effective magnetic device is described. A method to form a magnetic device is described. Various magnetic devices molded of ferromagnetic conductively doped resin-based materials are described. The electrical or thermal or visual characteristics of the magnetic device can be altered by forming a metal layer over the conductively doped resin-based material.

As shown in the preferred embodiments, the novel methods and devices of the present invention provide an effective and manufacturable alternative to the prior art.

While the invention has been particularly shown and described with reference to the preferred embodiments thereof, it will be understood by those skilled in the art that various changes in form and details may be made without departing from the scope of the invention.

What is claimed is:

1. A magnetic device comprising a ferromagnetic conductively doped, resin-based material comprising ferromagnetic micron conductive fiber in a base resin host wherein said ferromagnetic micron conductive fiber is magnetically polarized.

2. The device according to claim 1 wherein the percent by weight of said ferromagnetic micron conductive fiber is between about 20% and about 50% of the total weight of said ferromagnetic conductively doped resin-based material.

3. The device according to claim 1 further comprising ferromagnetic micron conductive powder.

4. The device according to claim 1 further comprising non-ferromagnetic micron conductive fiber.

5. The device according to claim 1 further comprising non-ferromagnetic micron conductive powder.

6. The device according to claim 1 wherein said ferromagnetic micron conductive fiber comprises a core material onto which is plated a metal.

7. The device according to claim 1 wherein said ferromagnetic micron conductive fiber comprises ferrite.

8. The device according to claim 1 wherein said ferromagnetic micron conductive fiber comprises ceramic.

9. The device according to claim 1 wherein said ferromagnetic micron conductive fiber comprises nickel zinc or manganese zinc.

10. The device according to claim 1 wherein said ferromagnetic micron conductive fiber comprises a combination of iron, boron, or strontium.

11. The device according to claim 1 wherein said ferromagnetic micron conductive fiber is a rare earth element.

12. The device according to claim 1 wherein said ferromagnetic conductively doped resin-based material is metal plated.

13. The device according to claim 1 wherein said ferromagnetic micron conductive fiber has a diameter of between about 3 μm and about 12 μm and a length of between about 2 mm and about 14 mm.

14. A magnetic device comprising a ferromagnetic conductively doped, resin-based material comprising ferromagnetic micron conductive fiber in a base resin host wherein said ferromagnetic micron conductive fiber is magnetically polarized and wherein said ferromagnetic micron conductive fiber is between about 20% and about 50% of the total weight of said ferromagnetic conductively doped resin-based material.

15. The device according to claim 14 further comprising ferromagnetic micron conductive powder.

16. The device according to claim 15 wherein said ferromagnetic micron conductive powder comprises a ferrite, a ceramic, or a rare earth element.

17. The device according to claim 14 wherein said ferromagnetic micron conductive fiber comprises a core material onto which is plated a metal.

18. The device according to claim 14 wherein said ferromagnetic conductively doped resin-based material is metal plated.

19. The device according to claim 14 wherein said ferromagnetic micron conductive fiber has a diameter of between about 3 μm and about 12 μm and a length of between about 2 mm and about 14 mm.

20. The device according to claim 14 wherein said ferromagnetic conductively doped resin-based material is flexible.

21. A method to form a magnetic device, said method comprising:
providing a ferromagnetic conductively doped, resin-based material comprising ferromagnetic micron conductive fiber in a resin-based host;
molding said ferromagnetic conductively doped, resin-based material; and
magnetically polarizing said ferromagnetic micron conductive fiber.

22. The method according to claim 21 wherein the percent by weight of said ferromagnetic micron conductive fiber is between about 20% and about 50% of the total weight of said ferromagnetic conductively doped resin-based material.

23. The method according to claim 21 wherein said ferromagnetic conductively doped, resin-based material further comprises ferromagnetic micron conductive powder.

24. The method according to claim 21 wherein said ferromagnetic micron conductive fiber comprises a core material onto which is plated a metal.

25. The method according to claim 21 further comprising a step of plating metal onto said magnetic device.

26. The method according to claim 21 wherein said step of molding comprises:
injecting said ferromagnetic conductively doped, resin-based material into a mold;
curing said ferromagnetic conductively doped, resin-based material; and
removing said ferromagnetic conductively doped, resin-based material from said mold.

27. The method according to claim 21 wherein said step of molding comprises:
loading said ferromagnetic conductively doped, resin-based material into a chamber;
extruding said ferromagnetic conductively doped, resin-based material out of said chamber through a shaping outlet; and
curing said ferromagnetic conductively doped, resin-based material.

28. The method according to claim 27 further comprising a step of cutting said ferromagnetic conductively doped, resin-based material.

29. The method according to claim 21 wherein said step of magnetically polarizing is performed concurrent with said step of molding.

30. The method according to claim 21 wherein said step of magnetically polarizing is performed after said step of molding.
